(19) United States
(12) Patent Application Publication
(10) Pub. No.: US 2023/0348299 A1
(43) Pub. Date: Nov. 2, 2023

(54) OZONE SPRAY WAND

(71) Applicant: Enozo Technologies, Inc., North Andover, MA (US)

(72) Inventors: Wayne Lieberman, North Andover, MA (US); Carl David Lutz, Andover, MA (US); Jeffrey D. Booth, Groton, MA (US); Brian Natale Arena, North Reading, MA (US); Brian Eller, North Andover, MA (US); Richard Armando Federico, Reading, MA (US); Xu Simon, North Andover, MA (US)

(21) Appl. No.: 18/076,961

(22) Filed: Dec. 7, 2022

Related U.S. Application Data
(63) Continuation of application No. PCT/US21/36196, filed on Jun. 7, 2021.
(60) Provisional application No. 63/036,221, filed on Jun. 8, 2020.

(51) Int. Cl. C02F 1/467; B05B 9/01

(52) U.S. Cl. CPC C02F 1/4672; B05B 9/01; C02F 2305/023; C02F 2103/02

(57) ABSTRACT

The ozone spray wand is a portable aqueous ozone generator that is adaptable to fit onto garden hoses, backpack sprayers or any other water supply source. The wand uses electrolytic cells to make ozone on-demand. An operator simply pulls the trigger and a solenoid valve starts delivering ozonated water. Embodiments use a rechargeable battery that allows it to operate for 1 hour between recharge cycles. The wand is rated for 500 hours of use which delivers 15,000 gallons of ozonated water.

### PRIORITY

This patent application is a continuation of PCT Application No. PCT/US2021/036196, filed Jun. 7, 2021, entitled, “OZONE SPRAY WAND,” and naming Wayne Lieberman, Carl David Lutz, Jeffrey D. Booth, Brian Natale Arena, Brian Eller, Richard Armando Federico, and Xu Simon as inventors [Attorney Docket No. 4540-11602], which claims priority to U.S. Provisional Application No. 63/036,221, filed Jun. 8, 2020 and titled “Ozone Spray Wand,” and naming Wayne Lieberman, Carl David Lutz, Jeffrey D. Booth, Brian Natale Arena, Brian Eller, Richard Armando Federico, and Xu Simon as inventors [Attorney Docket No. 4540-11601]

The disclosures of all of the above patent applications are incorporated herein, in their entireties, by reference.

### TECHNICAL FIELD

The present disclosure relates to ozone production, and more particularly, to apparatuses for producing ozone.

### BACKGROUND ART

Ozone is an effective killer of pathogens and bacteria, and consequently is an effective disinfectant. The US Food and Drug Administration has approved the use of zone as a sanitizer for food contact surface and for direct application to food products. Ozonated water can be used for a wide variety of application, such as water for drinking, ice-making, disinfecting surfaces, use in hot tubs, pools, spas and sinks.

It is known in the art to produce ozone from a plurality of water molecules by electrolytically separating the oxygen atoms from the hydrogen atom in each molecule of water, thereby producing a plurality of available oxygen atoms and a plurality of available hydrogen atoms. Some of the available oxygen atoms subsequently bond to one another to form ozone, while the hydrogen atoms flow away.

### BRIEF DESCRIPTION OF THE DRAWINGS

Features of embodiments will be more readily understood by reference to the following detailed description, taken with reference to the accompanying drawings, in which:

FIG. 1A schematically illustrates an embodiment of an ozone spray wand;

FIG. 1B schematically illustrates an embodiment of an ozone spray wand;

FIG. 2A schematically illustrates an embodiment of an ozone generating apparatus;

FIG. 2B schematically illustrates an embodiment of a handle;

FIG. 2C schematically illustrates another embodiment of a handle;

FIG. 3A schematically illustrates an embodiment of a wand system; and

FIG. 3B schematically illustrates an embodiment of a backpack-wand system.

### DETAILED DESCRIPTION OF SPECIFIC EMBODIMENTS

The ozone spray wand is a portable aqueous ozone generator that is adaptable to fit onto garden hoses, backpack sprayers or any other water supply source. The wand uses electrolytic cells to make ozone on-demand. An operator simply pulls the trigger and a solenoid valve starts delivering ozonated water. Embodiments use a rechargeable battery that allows it to operate for 1 hour between recharge cycles. The wand is rated for 500 hours of use which delivers 15,000 gallons of ozonated water.

Definitions: As used in this description and the accompanying claims, the following terms shall have the meanings indicated, unless the context otherwise requires.

A “set” includes at least one member.

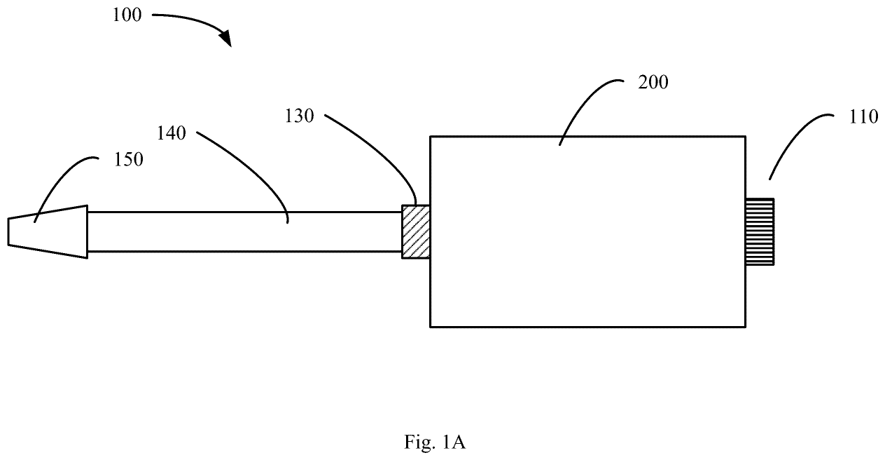

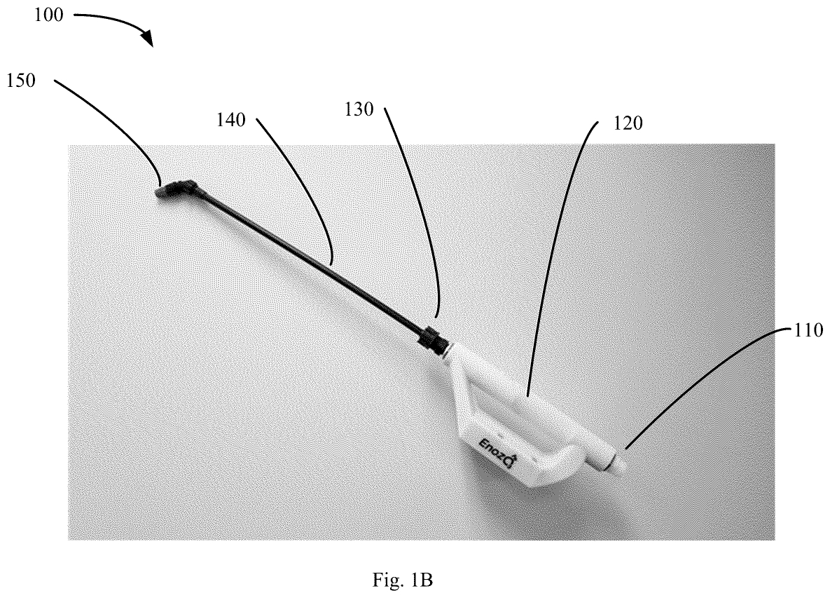

FIG. 1A schematically illustrates an embodiment of an ozone spray wand 100. The wand 100 includes a water inlet 110 to receive source water from a water source, and an ozonated water outlet 150. The water inlet 110 and ozonated water outlet 150 are in fluid communication through a water flow path. In operation, source water enters the wand 100 though the water inlet and is ozonated by an ozone generator apparatus 200 which produces ozonated water through electrolysis of source water. The ozonated water exits the ozone generator apparatus 200 through an ozonated water outlet port 130 into an ozonated water attachment 140. In some embodiments, the ozonated water attachment 140 is a tube having one end fluidly-coupled to the water outlet port 130, and a distal end having the ozonated water outlet 150, which may be a nozzle. A nozzle 150 may expel ozonated water as an ozonated spray, or in some embodiments as an ozonated stream. In other embodiments, the ozonated water attachment 140 is a non-spraying spout useful for delivering ozonated water to a bucket or other vessel, for example, or a tank for receiving and storing ozonated water. In illustrative embodiments, each of the water inlet 110 and the outlet port 130 is a ½″ NPT fitting.

FIG. 1B schematically illustrates another embodiment of an ozone spray wand 100 having a handle 120. In illustrative embodiments, the handle 120 sized and configured to be grasped by a human hand.

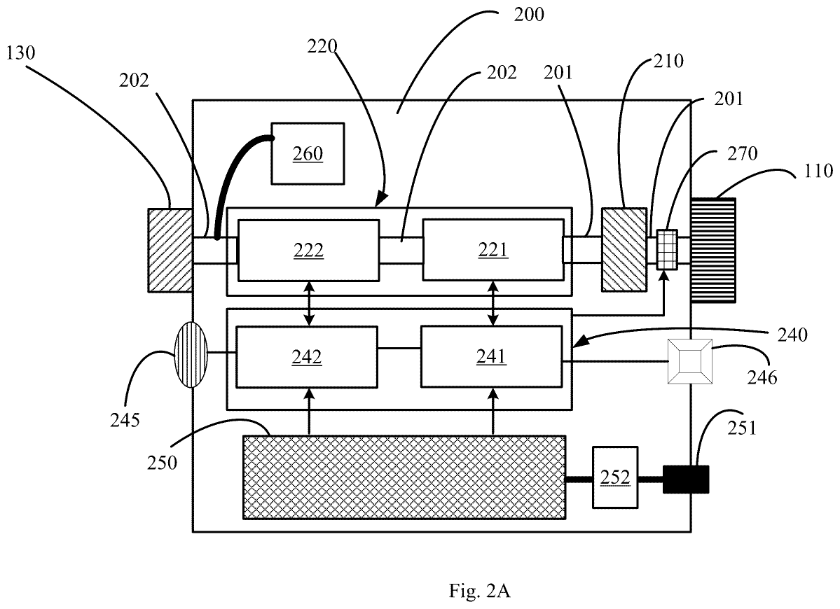

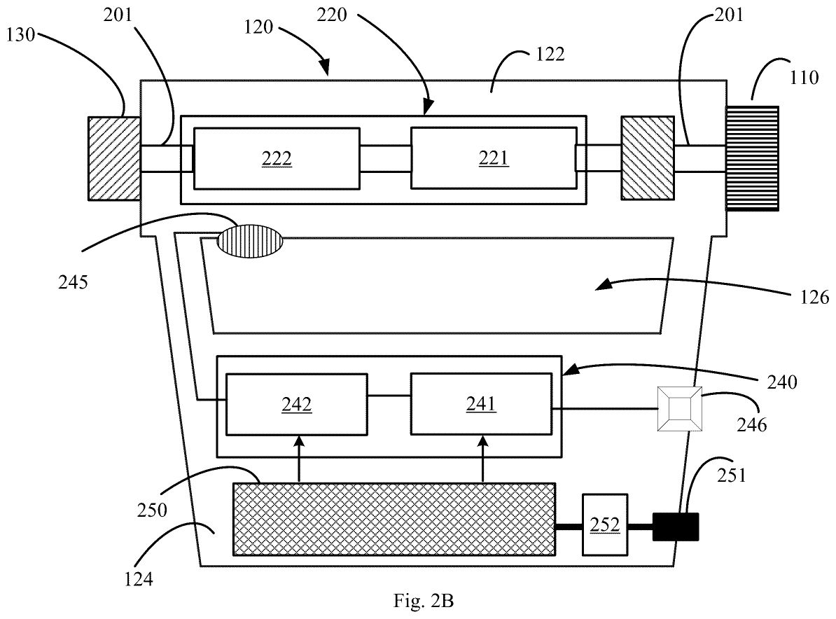

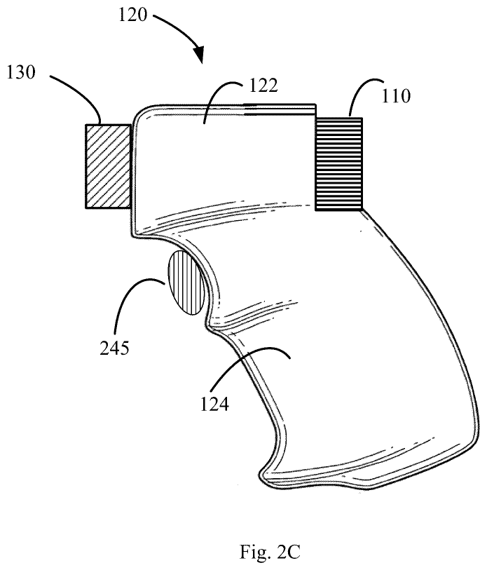

FIG. 2A schematically illustrates an embodiment of an ozone generating apparatus 200.

Some embodiments of the ozone generating apparatus 200 include a water flow regulator 210 in fluid communication with the source water inlet 110 via water conduit 201. The water flow regulator 210 conditions incoming source water to produce conditioned water. In some embodiments, the water flow regulator 210 regulates the pressure (e.g., kPa) of incoming source water, and in some embodiments, the water flow regulator 210 regulates the flow rate (e.g., liters/minute) of incoming source water. For example, in preferred embodiments, the water flow regulator 210 regulates the water flow to about one liter/minute.

Some embodiments of the wand 100 also include a controllable valve 270 (e.g., a solenoid valve), for example in the water inlet 110 or in the water flow regulator 210, or disposed downstream from the water flow inlet, such as between the water inlet 110 and the water flow regulator (if present). The controllable valve 170 is normally closed, to prevent water from reaching the electrolytic cell assemble 220, until the trigger 245 is activated. When the trigger 245 is activated, the controllable valve 270 opens to allow source water to flow and reach the electrolytic cell assembly. The controllable valve 270 may be in control communication with the control assembly 240, and the control assembly 240 controls the opening and closing of the valve 270 in response to the state of the trigger 245.

Illustrative embodiments of the ozone generating apparatus 200 include an electrolytic cell assembly 220 in fluid communication with the inlet 110, in some embodiments via the water flow regulator 210 and/or valve 270. The electrolytic cell assembly 220 includes a set of electrolytic cells that produce ozonated water from source water (which may be conditioned water).

Some embodiments the electrolytic cell assembly 220 include a single electrolytic cell 221, and some embodiments the electrolytic cell assembly 220 includes a plurality of electrolytic cells 221, 222. The illustrative embodiment of FIG. 2A includes a first electrolytic cell 221 and a second electrolytic cell 222 disposed in fluid series, such that ozonated water from one electrolytic cell 221 flows into another, downstream electrolytic cell 222, and ozonated water leaving the downstream electrolytic cell 222 forms a stream of ozonated water.

In other embodiments, the plurality of electrolytic cells are disposed in fluid parallel, such that source water (or conditioned water) splits into a plurality of flow paths, each of which flows through a corresponding one of the electrolytic cells 221, 222. In such embodiments, ozonated water leaving each of the electrolytic cells 221, 222 recombines downstream to form a stream of ozonated water.

In either embodiment, the stream of ozonated water exits the electrolytic cell assembly 220 and flows to the ozonated water outlet 130.

The ozone generating apparatus 200 also includes a controller assembly 240. The controller assembly 240 includes a set of cell controllers. In some embodiments, a single cell controller 241 controllably supplies power to each electrolytic cell in the set of electrolytic cells 220. In other embodiments, the set of cell controllers of the controller assembly 240 includes a plurality of cell controllers 241, 242, each cell controller of the plurality of cell controllers 241, 242 coupled in electrical communication with a corresponding one of the electronic cells 221, 222.

Power to an electrolytic cell 242, 242 preferably is in the form of a fixed electrical current. To that end, the controllers 242, 243 preferably include a current source, which current source produces a prescribed electrical current irrespective of changes in the load presented by its corresponding electrolytic cell 221, 222.

Illustrative embodiments of the wand 100 also include a trigger 245. When activated by a user, the trigger 245 causes the controller assembly 240 to engage an activated state in which it activates (e.g., provide power to) the electrolytic cell assembly 220.

Some embodiments of the wand 100 include a lamp (e.g., a light emitting diode) 246 that illuminates when the controller assembly 240 is in an activated state. In some embodiments, the lamp signals that each electrolytic cell is receiving sufficient electrical current to produce a pre-determined amount of ozone.

In illustrative embodiments, the lamp 246 is disposed on or at the ozone generating apparatus 200, but in other embodiments the lamp 246 is disposed at other locations, such as on the ozonated water attachment 140 or at the ozonated water outlet (e.g., nozzle) 150.

In some embodiments, the ozone generating apparatus 200 also includes a battery 250. In illustrative embodiments, the battery 250 is a rechargeable Li-Ion battery sufficient to provide power for 1 hour of use in the wand 100 between charges.

The battery 250 may be electrically coupled to a power port 250 to receive electrical power from an external source. To that end, some embodiments include a battery charging circuit 252 (which may be an active circuit; and which may include a voltage regulator or current source), to receive external electrical power and condition or regulate that power, and to provide conditioned electrical power to the battery 250.

Some embodiments also include an additive source 260 in fluid communication with the water path. The additive source 260 stores, and delivers to water flowing through the wand 100, one or more additives. For example, in some embodiments the additive source 260 stores and provides a basic solution to increase the pH of the water (i.e., to reduce the acidity of the water).

In some embodiments, the handle 120 of wand 100 has an interior, and the ozone generating apparatus 200 is integrated with (e.g., disposed within) the interior of the handle 120. An embodiment of such a handle 120 is schematically illustrated in FIG. 2B. In some embodiments, the handle 120 includes an upper chamber 122 and a lower chamber 124, and the component so the ozone generating apparatus are distributed among the upper chamber 122 and lower chamber 124. In preferred embodiments, the upper chamber 122 is fluidly isolated from the lower chamber 124. Among things, this protects components of the lower chamber 124 from water that may leak into the upper chamber 122.

In the illustrative embodiment of FIG. 2B, the upper chamber 122 houses the electrolytic cell assembly 220 (in other words, the electrolytic cell assembly 220 is disposed within the upper chamber 122), and the lower chamber 124 houses the controller assembly 240 (in other words, the controller assembly 240 is disposed within the lower chamber 124). In some embodiments, the lower chamber 124 may also house a battery 250, and may also include a charger circuit 252.

As schematically illustrated in FIG. 2B, the upper chamber 122 is physically coupled to the lower chamber 124 so as to define a handle opening 126 configured to receive fingers of a human hand when the human hand grasps the handle 120.

In some embodiments, the trigger 245 is disposed on the upper chamber 122 of the handle 120, with the trigger 245 facing the handle opening 126 such that the trigger 245 is within reach of, and can be activated by, a human finger within the handle opening when the human hand grasps the handle 120.

Handle embodiments as schematically illustrated in FIG. 2B provide several advantages. For one, distribution of components of the ozone generator apparatus 200 among the upper chamber 122 and lower chamber 124 allow a wand designer to balance the weight of those component with respect the hand of a user. Such balance beneficially tends to reduce hand and arm fatigue of the user. Moreover, the lower chamber 124 serves as a physical shield to protect the fingers of a user grasping the handle. This may be a particularly desirable feature when the wand 100 is used in confined spaces (e.g., subway cars) where the user moves the wand 100 around obstacles (e.g., seats; seat backs; railings) with a risk of contact with such obstacles. In addition, disposing the battery in a separate compartment (e.g., the lower compartment 124) than the electrolytic cell assembly 220 allow a user to replace a battery 250 with a new battery without having to expose the electrolytic cell assembly 220 to the environment outside of the handle 120/ozone generating apparatus 200.

In other embodiments, the handle 120 has a pistol grip shape, as schematically illustrated in FIG. 2C for example. Some such embodiments also include an upper chamber 122 and lower chamber 124. In some such embodiments, components of the ozone generator apparatus 200 are distributed within the upper chamber 122 and lower chamber 124 as described above. The trigger 245 is disposed on the pistol grip housing at a concave curve (e.g., in the position traditionally reserved for a trigger), as schematically illustrated in FIG. 2C.

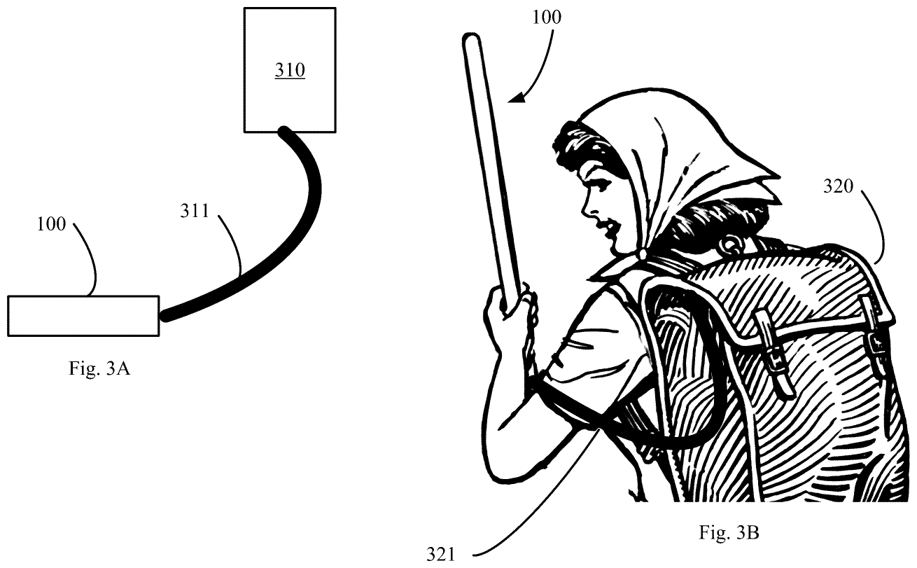

FIG. 3A schematically illustrates an embodiment of a wand system in which the wand 100 is supplied by an external source 310. For example, the external source 310 may be a water source that supplies source water to the wand 100 via a flexible water conduit 311 (e.g., a hose or tube).

FIG. 3B schematically illustrates an embodiment of a backpack-wand system. In this embodiment, the wand 100 is in communication with a backpack 320 via an umbilical 321. The backpack 320 is configured to be worn by a user, and to deliver water, power, or both, to a wand 100.

The backpack 320 may include a water source (e.g., 310), in which case the umbilical 321 includes a water conduit 311. In some embodiments, the backpack 320 may include a power source, such as a battery 250. In such embodiments, the umbilical 321 includes a power cable to deliver electrical power from the power source to the wand 100.

In some embodiments, the backpack 320 may include an additive source 260. In such embodiments, the umbilical 321 includes an additive conduit to deliver additive to the wand 100.

Some embodiments of the umbilical 321 include both a water conduit 311 and a power cable. Some embodiments of the umbilical 321 include both a water conduit 311 and an additive conduit. Some embodiments of the umbilical 321 include a water conduit 311, a separate additive conduit, and a power cable.

In illustrative embodiments, the electrolytic cells 221, 222, and their associated plumbing (e.g., ozonated water conduits 202) do not have separate paths for hydrogenated water—i.e., water bearing hydrogen ions produced by electrolysis in an electrolytic cell. Consequently, hydrogenated water mixes with ozonated water, and some hydrogen ions recombine with oxygen atoms to produce water, thereby suffering some loss of ozone. The electrolytic cell assembly 220, however, produces sufficient ozone that the loss to recombination is acceptable in that ozonated water expelled by the wand 100 retains sufficient ozone to be an effective disinfectant.

In preferred embodiments, the wand 100 does not include a pump. Consequently, water passing through the wand travels under pressure from its source (e.g., a municipal water supply, or from a pump in a backpack).

In illustrative embodiments, a user can adjust the source water regulator 210, and/or the nozzle 150, to control the volume of water flow and thereby control the ozone concentration (i.e., less water flow=higher ozone concentration, and more water flow—lower ozone concentration), given the amount of ozone produced by the electrolytic cells 221, 222. For example, in some embodiments the control assembly 240 is configured to drive the electrode assembly 229 to produce ozonated water with an ozone concentration of between 0.3-1.5 ppm, depending upon flowrate.

In an alternate embodiment, the user can control the ozone concentration in the ozonated water by controlling the rate of ozone production in the electrolytic cell assembly 220. For example, in some embodiments the control assembly 240 is configured to adjust the ozone production of the electrolytic cell assembly 220 to produce ozone on-demand between 0.3-1.5 ppm.

To that end, the control assembly 240 may configured to receive user input to control the rate of ozone production when the control assembly 240 is in the activated state. For example, a user may provide such input by controlling the quantity of displacement of the trigger 240 (e.g., greater displacement causes the controller module 240 to increase power to the electrolytic cells).

When used after some time of non-use, the wand may hold “dead” water—water that is already downstream from the electrolytic cell assembly when the electrolytic cell assembly 220 is activated—, and therefore does not include ozone. Such water will be expelled from the wand 100 before any new ozonated water. Consequently, that first slug of water expelled from the wand 200 is not ozonated.

In some embodiments, illumination of the light 246 is delayed, relative to the time the trigger 245 is activated by a user, to give time for that initial slug of non-ozonated water to be expelled, so that the user does not interpret the illuminated LED as indicating that ozonated water is being dispensed.

The duration of such a delay may be established to be long enough to ensure that the dead water is gone, and that, in turn, depends on the dead-water storage capacity of the wand 100. Consequently, some embodiments are be able to determine what type of attachment 140 (e.g., a 12 inch wand; a 1 meter wand; a 1 cm nozzle, a tank, etc.) is coupled to the outlet 130. Such an embodiment may work by having electronic identifier means in the wand (e.g., Bluetooth; a near-field communication (“NFC”) device, or mechanical interface) that identifies, to the controller assembly, the attachment 140, so the controller assembly can and automatically does select an appropriate delay, accordingly.

A listing of certain reference numbers is presented below.
100: Ozone spray wand;
110: Source water inlet port;
120: Handle;
122: Upper chamber;
124: Lower chamber;
126: Handle opening;
130: Ozonated water outlet port;
140: Ozonated water attachment (e.g., tube);
150: Nozzle;
200: Ozone generator apparatus;
201: Water conduit;
202: Ozonated water conduit;
210: Water flow regulator;
220: Electrolytic cell assembly;
221: First electrolytic cell;
222: Second electrolytic cell;
240: Controller assembly;
241: First cell controller;
242: Second cell controller;
245: Trigger;
246: Light;
250: Battery;
251: Power port;
252: Battery charging circuit;
260: Additive source;
310: Water supply;
311: Waterline;
320: Waterpack;
321: Umbilical.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the invention described above are intended to be merely exemplary; numerous variations and modifications will be apparent to those skilled in the art. All such variations and modifications are intended to be within the scope of the present invention as defined in any appended claims.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

What is claimed is:

1. A pump-less wand for producing and delivering ozonated water spray, comprising:
a source water inlet port configured to receive source water from a water source;
a pumpless water regulator in downstream fluid communication with the source water inlet port, the water regulator configured to condition at least one of the pressure and flowrate of source water from the source water inlet port to produce conditioned water;
an electrolytic cell assembly in downstream fluid communication with the water regulator to receive conditioned water from the water regulator, the electrolytic cell assembly comprising a set of electrolytic cells to electrolyze the conditioned water to produce ozonated water; and
a nozzle in downstream fluid communication with the electrolytic cell assembly to receive the ozonated water from the electrolytic cell assembly and dispense the ozonated water from the wand.

2. The wand of claim 1, further comprising a controller assembly comprising electronics configured to controllably drive the set of electrolytic cells in the electrolytic cell assemble.

3. The wand of claim 1, wherein:
the set of electrolytic cells comprises a plurality of electrolytic cells; and
the controller assembly comprises a corresponding plurality of control circuits, each control circuit coupled to a corresponding electrolytic cell of the plurality of electrolytic cells to drive said corresponding electrolytic cell.

4. The wand of claim 1, further comprising a battery in power communication with the electrolytic cell assembly and the controller assembly.

5. The wand of claim 1, further comprising a handle sized and configured to be grasped by a human hand, the handle comprising an interior, wherein the electrolytic cell assembly, and the controller assembly are contained within the interior of the handle.

6. The wand of claim 5, wherein the handle comprises:
an upper chamber housing the electrolytic cell assembly; and
a lower chamber housing the controller assembly;
wherein the upper chamber and the lower chamber define a handle opening configured to receive fingers of a human hand when the human hand grasps the handle.

7. The wand of claim 6, wherein the trigger is disposed on the upper chamber of the handle facing the handle opening to be within reach of a human finger within the handle opening when the human hand grasps the handle.
